(19) United States
(12) Patent Application Publication
(10) Pub. No.: US 2022/0400525 A1
(43) Pub. Date: Dec. 15, 2022

(54) METHOD AND SYSTEM FOR COMMUNICATING OVER OVERLAY NETWORKS

(71) Applicant: SAMSUNG SDS CO., LTD., Seoul (KR)

(72) Inventors: Jun Won LEE, Seoul (KR); Geun Young YOO, Seoul (KR); Bong Gu KANG, Seoul (KR)

(21) Appl. No.: 17/837,424

(22) Filed: Jun. 10, 2022

(30) Foreign Application Priority Data
Jun. 10, 2021 (KR) 10-2021-0075324

(51) Int. Cl. H04W 76/12; H04W 12/069

(52) U.S. Cl. CPC H04W 76/12; H04W 12/069

(57) ABSTRACT

A method for communicating overlay networks according to an embodiment of the present disclosure includes acquiring a first authentication information from a first authentication server by the first terminal, establishing a connection with a first relay node based on the first authentication information by the first terminal, acquiring a second authentication information from a second authentication server via the first relay node by the first terminal, and communicating with the second terminal by way of the first relay node using the second authentication information by the first terminal.

### CROSS-REFERENCE TO RELATED APPLICATION AND CLAIM OF PRIORITY

This application claims the benefit under 35 USC § 119 of Korean Patent Application No. 10-2021-0075324 filed on Jun. 10, 2021, in the Korean Intellectual Property Office, the entire disclosure of which is incorporated herein by reference for all purposes.

### BACKGROUND

### 1. Technical Field

The present disclosure relates to a method for communicating over overlay networks and a network system for performing the method. More particularly, the present disclosure relates to a network communication method and a network system with safety that is lightweight and can block security threats while requiring a minimum computing resource.

### 2. Description of the Related Art

An Internet network for IoT services may be established over a public Internet and/or a trusted Internet.

Since third-party access to the trusted Internet is restricted, it may be relatively safe from an attacker's threats. However, client terminals and server devices for providing IoT services may be physically far apart, and in particular, the number of client terminals is generally very large. Therefore, there is a need to invest a large amount of money to establish a trusted Internet network between individual client terminals and servers.

Meanwhile, a public Internet network is a network that anyone can access. FIG. 1 is a view illustrating an exemplary appearance in which IoT devices (client terminals) for providing IoT services and IoT servers are connected to each other over a public Internet network. Compared to the trusted Internet, the public Internet is often exposed to greater risks caused by a server administrator's carelessness and an attacker's threats. In addition, when the client terminal and the server are physically far apart, some sections of the public Internet between the client terminal and the server may be threatened by the attacker's path modulation and sniffing attacks. When a gateway installed and managed by the final user is not safely managed, attacks such as DNS manipulation, traffic bypass, and DoS may occur due to unauthorized access by attackers not only on the server side, but also in the home IoT network environment where the client terminal is located. Furthermore, when the server does not strongly authenticate the client device, maliciously modulated or unallowed devices can connect to the IoT services.

Message Queuing Telemetry Transport (MQTT) and Constrained Application Protocol (CoAP), some of which are communication protocols frequently used in IoT services, are lightweight application protocols that can be used to transmit messages between IoT devices with restricted resources, but MQTT and CoAP do not provide encryption by themselves. For this reason, MQTT and CoAP need to use additional protocols such as SSL/TLS for transmitting encrypted data, but for communication depending on SSL/TLS, a key exchange process needs to be essentially undergone for each session created between devices. However, this may excessively increase the number of key exchange processes for IoT devices exchanging data between multiple devices. Therefore, the computing power provided to achieve the purpose of IoT devices may be wasted during processing of key exchanges, which may be an obstacle to lightening IoT devices.

Therefore, in a service network in which a plurality of small and lightweight devices such as IoT services participate, there is need for a network system that enables devices with low computing power to operate smoothly while providing high security, and offer reasonable cost in network construction.

### SUMMARY

Technical aspects to be achieved through one embodiment by the present disclosure provide a network communication method and a network system with safety that is lightweight and can block a security threat while requiring a low computing resource.

Technical aspects to be achieved through one embodiment by the present disclosure also provide a separated service network system in which a plurality of terminals may be connected to each other without any limitation on the number of terminals.

Technical aspects to be achieved through one embodiment by the present disclosure also provide a service network system capable of minimizing a security threat that may be present in an Internet network connecting terminals/servers located at a long distance.

Technical aspects to be achieved through another embodiment by the present disclosure provide a service network system capable of processing authentication of a terminal by a secure network node rather than a home gateway that is vulnerable to security.

Technical aspects to be achieved through another embodiment by the present disclosure provide an efficient service network system for providing end-to-end encryption in a manner capable of working smoothly even in a lightweight terminal device connected to a low-bandwidth network.

Technical aspects to be achieved through another embodiment by the present disclosure provide an efficient service network system for providing end-to-end encryption in a manner capable of smoothly working even in a lightweight terminal device connected to a low-bandwidth network.

The technical aspects of the present disclosure are not restricted to those set forth herein, and other unmentioned technical aspects will be clearly understood by one of ordinary skill in the art to which the present disclosure pertains by referencing the detailed description of the present disclosure given below.

According to an embodiment of the present disclosure, there is provided a method for communicating between a first terminal and a second terminal. The method includes acquiring a first authentication information from a first authentication server by the first terminal, establishing a connection with a first relay node based on the first authentication information by the first terminal, acquiring a second authentication information from a second authentication server via the first relay node by the first terminal, and communicating with the second terminal by way of the first relay node using the second authentication information by the first terminal.

According to another embodiment of the present disclosure, there is provided a communication relaying method for relaying communication between terminals on a network. The communication relaying method includes forming a plurality of overlay networks with a plurality of relay nodes by a first relay node, establishing a connection with a first terminal by the first relay node, acquiring authentication request information of the first terminal from the first terminal by the first relay node, acquiring authentication information for the first terminal from an authentication server based on the authentication request information, and connecting the first terminal to an overlay network corresponding to the authentication information among the plurality of overlay networks by the first relay node.

According to an embodiment of the present disclosure, there is provided a network system. The network system includes a plurality of terminals, a plurality of relay nodes, and an authentication server, wherein a first terminal of the plurality of terminals establishes a connection with a first relay node closest to the first terminal among the plurality of relay nodes based on a first authentication information acquired from the authentication server, acquires a second authentication information via the first relay node, and performs communication between the first terminal and a second terminal of the plurality of terminals, protected by a MACsec protocol by way of the first relay node using the second authentication information, wherein the plurality of relay nodes forms a plurality of overlay networks, wherein the first relay node of the plurality of relay nodes acquires the second authentication information for the first terminal to provide the second authentication information to the first terminal based on authentication request information acquired from the first terminal, and connects the first terminal to an overlay network corresponding to the second authentication information among the plurality of overlay networks.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a view illustrating an exemplary appearance in which IoT devices and IoT servers are connected over a public Internet network;

FIG. 2 is a view illustrating an exemplary network system according to one embodiment of the present disclosure;

FIG. 3 is a view explaining a network system described with reference to FIG. 2 in more detail;

FIG. 4 is a view illustrating a manner in which communication between terminals is protected in a network system according to some embodiments of the present disclosure;

FIG. 5 is a flowchart explaining an exemplary process in which a connection is established between devices in an exemplary network system according to another embodiment of the present disclosure;

FIG. 6 is a flowchart illustrating an exemplary method in which a first terminal communicates with a second terminal in a network system according to some embodiments of the present disclosure;

FIG. 7 is a flowchart explaining some steps of the method described with reference to FIG. 6 in more detail;

FIG. 8 is a flowchart explaining exemplary operations performed by a relay node in a network system according to some embodiments of the present disclosure; and

FIG. 9 is a view illustrating a hardware configuration of the terminal device described according to some embodiments of the present disclosure.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, various embodiments of the present disclosure will be described with reference to the attached drawings:

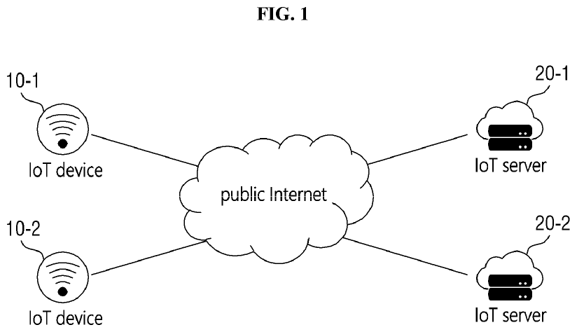

FIG. 1 is a view illustrating an exemplary appearance in which IoT devices 10-1 and 10-2 and IoT servers 20-1 and 20-2 are connected over a public Internet network. Because the public Internet network is a network that anyone can access, some sections of the public Internet may be threatened by an attacker's path modulation and sniffing attacks. In addition, in the home IoT network environment where client terminals 10-1 and 10-2 are located, when the gateway installed and managed by the final user is not securely managed, attacks such as DNS manipulation, traffic bypass, and DoS may occur due to unauthorized access by attackers. Furthermore, when the servers 20-1 and 20-2 do not strongly authenticate the client devices 10-1 and 10-2, any maliciously modulated or unauthorized devices can be connected to IoT services without permission.

As illustrated in FIG. 1, in order to provide an IoT service that is safe from security threats over a network consisting of the public Internet, a virtual private network (VPN) needs to be established between IoT devices and IoT servers and communication between the devices needs to be encrypted. However, communication using TCP/IP-based VPNs and conventional encryption protocols is often unsuitable for small and lightweight IoT devices with limited computing power and resources.

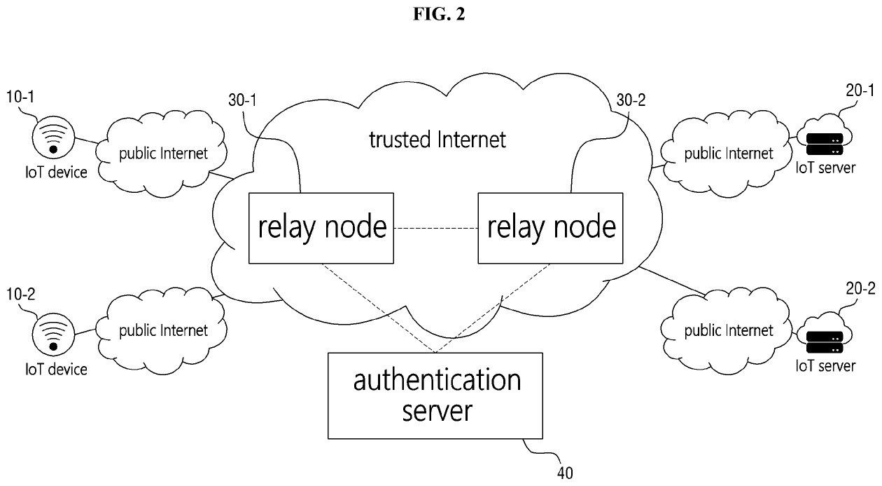

FIG. 2 is a view illustrating an exemplary network system according to one embodiment of the present disclosure. The network system according to the present embodiment may be distinguished from the network illustrated in FIG. 1, in which the IoT devices 10-1 and 10-2 and the IoT servers 20-1 and 20-2 are directly connected to the public Internet.

Referring to FIG. 2, the network system according to the present embodiment may further include relay nodes 30-1 and 30-2 and an authentication server 40.

In the network system according to the present embodiment, the relay nodes 30-1 and 30-2 may relay data exchange between the IoT devices 10-1 and 10-2 and the IoT servers 20-1 and 20-2. In other words, the IoT devices 10-1 and 10-2 and the IoT servers 20-1 and 20-2 may exchange data with each other by way of the relay nodes 30-1 and 30-2.

In the network system according to the present embodiment, the authentication server 40 may authenticate the IoT devices 10-1 and 10-2 and the IoT servers 20-1 and 20-2, and may or may not provide authentication information necessary to access a certain network. As will be described later, the IoT devices 10-1 and 10-2 and the IoT servers 20-1 and 20-2 may acquire authentication from the authentication server 40, thereby forming an L2TP tunnel between the IoT devices or IoT servers and the relay nodes 30-1 to 30-4, which is to be described later. In addition, the IoT devices 10-1, 10-2 and the IoT servers 20-1, 20-2 may be connected to a VXLAN overlay network to be described later by acquiring authentication from the authentication server 40. The authentication server 40 may include an L2TP authentication server and an 802.1X authentication server, and the authentication server 40 may be implemented by integrating the two servers into one hardware or may be implemented in two or more hardware, respectively.

In the network system according to the present embodiment, the IoT devices 10-1 and 10-2 and the relay nodes 30-1 and 30-2 may be connected to each other over the public Internet network, and the IoT servers 20-1 the 20-2 and the relay nodes 30-1 and 30-2 may also be connected to each other over the public Internet network. In the network system according to the present embodiment, the relay nodes 30-1 and 30-2 may be connected to each other via the trusted Internet, and the relay nodes 30-1 and 30-2 and the authentication server 40 may also be connected to each other via the trusted Internet.

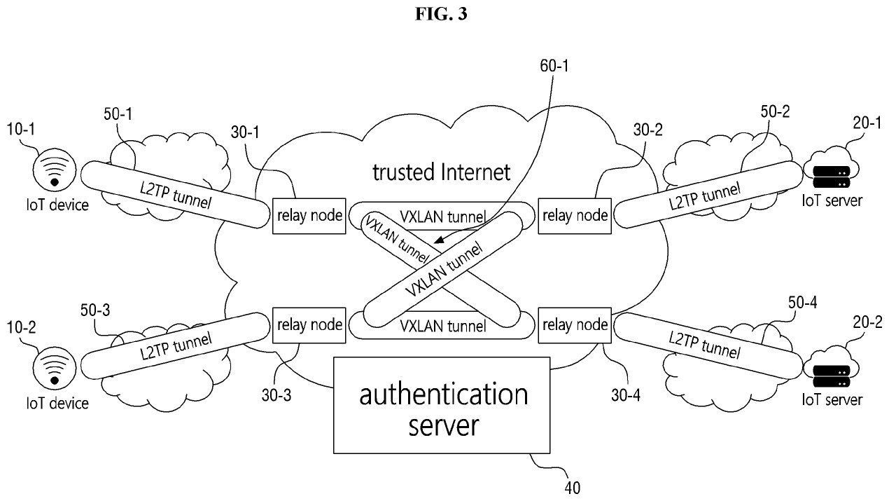

FIG. 3 is a view explaining a network system described with reference to FIG. 2 in more detail.

Referring to FIG. 3, L2TP tunnels 50-1 and 50-3 may be formed between the IoT devices 10-1 and 10-2 and the relay nodes 30-1 and 30-3 connected over the public Internet network, and similarly, L2TP tunnels 50-2 and 50-4 may be formed between the IoT servers 20-1 and 20-2 and the relay nodes 30-2 and 30-4 connected over the public Internet network.

Herein, a layer 2-based Tunneling Protocol (L2TP) is a tunneling protocol that supports a virtual private network of layer 2. L2TP encapsulates a layer 2-based packet (e.g., PPP) for transmission over the network. In general, both endpoints of the L2TP tunnel are L2TP access concentrator (LAC) and L2TP network server (LNS). The L2TP access concentrator (LAC) configured in an access device may receive packets from a remote client and transmit them to the L2TP network server (LNS) on the remote network, and the LNS can serve as a logical end point of a layer 2-based session tunneled by the LAC on the remote client.

In the exemplary network system illustrated in FIG. 3, it may be understood that several IoT devices 10-1 and 10-2 and IoT servers 20-1 and 20-2 may correspond to LACs, respectively, and the relay nodes 30-1 to 30-4 located on the opposite side of the L2TP tunnel serve as the LNS. In the exemplary network system illustrated in FIG. 3, the L2TP tunnel may be an L2TPv3 tunnel that supports unicast, broadcast, and multicast.

Meanwhile, L2TP authentication information may be required so that the devices 10-1 and 10-2 and the servers 20-1 and 20-2 form an L2TP tunnel 50-1 to 50-4 of the relay nodes 30-1 to 30-4. Each of the devices 10-1 and 10-2 and the servers 20-1 and 20-2 may acquire the L2TP authentication information from the authentication server 40, where the authentication server 40 may be an L2TP authentication server. The authentication server 40 may receive authentication request information such as device identification information (ID) and password information (PW) from each of the devices 10-1 and 10-2 and the servers 20-1 and 20-2 and, when authentication is successful, the authentication server 40 may provide the identification information, a network address (URL, IP address, etc.) and the L2TP authentication information (e.g., tunnel ID and session ID) of the relay nodes 30-1 to 30-4 to be connected to each device or each server. The devices 10-1 and 10-2 or the servers 20-1 and 20-2 which have acquired the authentication information from the authentication server 40 may form appropriate relay nodes 30-1 to 30-4 and L2TP tunnels 50-1 to 50-4, respectively, using the authentication information.

Referring to FIG. 3, a VXLAN type overlay network may be formed between the relay nodes 30-1 to 30-4 connected over the trusted Internet network. Specifically, different VXLAN tunnels corresponding to a variety of services that may be provided via the network system illustrated in FIG. 3 may be formed between the relay nodes 30-1 to 30-4, thereby providing a virtual network separated for each service.

Virtual Extensible LAN (VXLAN) is a network virtualization technology developed to solve scalability problems in large-scale cloud computing. Specifically, VXLAN is an encapsulation technology that may expand a layer 2-based connection over a layer 3-based network using tunneling. The VXLAN technology may provide a virtualized overlay network that provides 16 million network identifiers (VNIDs), to a cloud. For example, virtual layer 2-based networks may be provided for each different service. In other words, the unique separate virtual network may be provided for each service, and it is possible to restrict access to any device unauthorized for each service.

A node configured to encapsulate and decapsulate packets in a virtual network created by the VXLAN technology is referred to as a VXLAN Tunnel Endpoint (VTEP). In the exemplary network system illustrated in FIG. 3, it may be understood that each of the relay nodes 30-1 to 30-4 serves as the VTEP.

As a result, in the exemplary network system illustrated in FIG. 3, the relay nodes 30-1 to 30-4 may be understood as nodes that serve as LNS at one end of the L2TPv3 tunnel and serve as the VTEP at one end of the VXLAN tunnel at the same time. Specifically, the relay nodes 30-1 to 30-4 may serve as connecting the L2TP tunnel formed between the relay nodes 30-1 to 30-4 and the IoT devices 10-1 and 10-2 and the IoT servers 20-1 and 20-2 to an appropriate tunnel among the VXLAN tunnels formed between the other relay nodes 30-1 and 30-4.

For example, the IoT device 10-1 and the IoT server 20-2 providing a certain IoT service may be connected to the relay node 30-1 and the relay node 30-4, respectively, through the L2TP tunnels 50-1 and 50-4. The relay node 30-1 and the relay node 30-4 may be connected to each other via a VXLAN tunnel 60-1 configured to provide a separate virtual overlay network for providing the IoT service. The relay node 30-1 may connect the L2TP tunnel 50-1 formed between the relay node 30-1 and the IoT device 10-1 to the VXLAN tunnel 60-1, and the relay node 30-4 may connect the L2TP tunnel 50-4 formed between the relay node 30-4 and the IoT server 20-2 to the VXLAN tunnel 60-1, resulting in providing a connection between the IoT device 10-1 and IoT server 20-2.

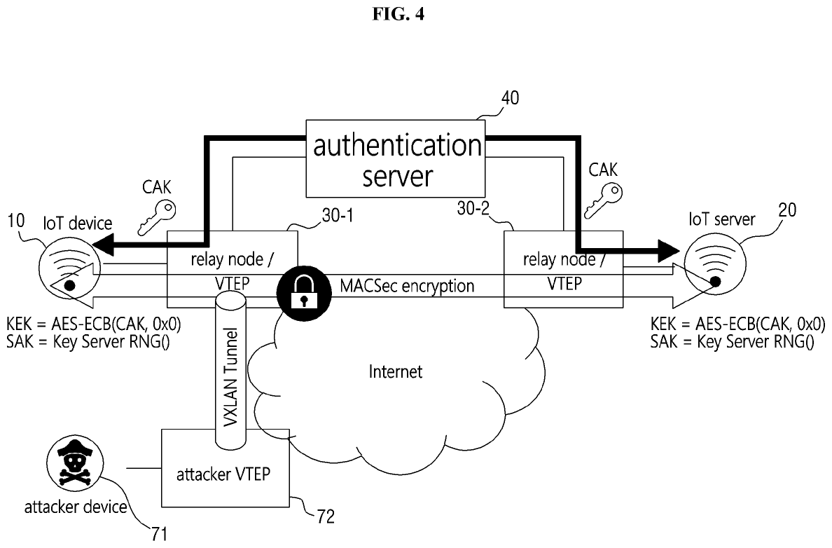

Next, a manner in which communication between terminals is protected in a network system according to some embodiments of the present disclosure will be described with reference to FIG. 4. FIG. 4 may be referenced to understand, for example, the manner in which communication between the IoT devices 10-1 and 10-2 and the IoT servers 20-1 and 20-2 is protected in the network system illustrated in FIG. 3.

Since the L2TP tunneling protocol itself used in the embodiment illustrated in FIG. 3 does not provide encryption, a separate means for protecting data transmitted and received via the L2TP tunnel may be required. Meanwhile, since the overlay network established through the VXLAN technology used in the embodiment illustrated in FIG. 3 provides information necessary for access to a specific VXLAN only for a device that has been authenticated, access of unauthorized devices may be basically blocked. However, when the leakage of the information necessary for access to the specific VXLAN network occurs due to malicious attacks or security vulnerabilities, there is a risk that the unauthorized devices may access the specific VXLAN and may intercept data between other devices connected to the corresponding VXLAN.

In order to prevent the above problem, in the network system according to some embodiments of the present disclosure, data security may be provided according to the MACsec (802.1AE) protocol.

MACsec is a layer 2-based security protocol that provides encryption and integrity for a data link layer frame. Since the MACsec has high transmission efficiency by using a header with a smaller size than IPsec, it may be applied to a layer 2-based IoT network provided at a low bandwidth such as long range (LoRa) wide area network (WAN). Since the MACsec can implement physical port-based encryption and decryption, it is a protocol suitable for high-speed and lightweight connections. Meanwhile, to apply the MACsec, a layer 2-based network capable of unicast, broadcast, and multicast is required. The MACsec can identify and prevent a variety of security threats such as denial of service (DoS), intrusion, man-in-the-middle attacks, masquerading, and playback attacks.

Referring to FIG. 4, in the network system according to some embodiments of the present disclosure, the devices such as the IoT device 10 and the IoT server 20 may acquire a connectivity association key (CAK, hereinafter referred to as “a shared key”) for establishing a connection through authentication of the authentication server 40. Herein, the authentication server 40 may be, for example, an 802.1X authentication server.

Each of the devices 10 and 20 may derive a key encryption key (KEK) from the shared key. Specifically, the devices 10 and 20 may acquire the key encryption key KEK by inputting the shared key acquired from the authentication server 40 into a predefined function. In other words, the devices 10 and 20 may share the same key encryption key KEK derived from one shared key CAK acquired from the same authentication server 40.

Meanwhile, the devices 10 and 20 may generate a secure encryption key (SAK; hereinafter referred to as “a session key”) for securely protecting their own data, and may be used to protect data exchanged with other devices.

Specifically, the devices 10 and 20 may generate their unique session keys SAKs by using a variety of conventional methods for generating an arbitrary encryption key, for example, a random value generation function. In addition, one of the devices 10 and 20 may encrypt its own session key SAK using the key encryption key KEK and provide the encrypted session key SAK to the other device 20, for example, when initiating a communication session with the other device 20. Thereafter, the device 10 may transmit the encrypted data to the device 20 using its own session key SAK.

The device 20 which has obtained the encrypted session key SAK from the device 10 may decrypt the session key SAK of the device 10 using the key encryption key KEK stored therein. Thereafter, the device 20 may decrypt and read data received from the device 10 using the session key SAK of the device 10.

Similarly, when initiating the communication session with the device 10, the device 20 may encrypt its unique session key SAK using the key encryption key SAK, and provide the encrypted session key SAK to the device 10. Then, data transmitted to the device 10 may encrypted and protected with the session key SAK of the device 20.

According to the aforementioned method, each of the devices 10 and 20 may encrypt their session keys SAKs using the shared key CAK received from the authentication server 40 and provide them to a communication counterpart device, and the data (payload) exchanged with each other may be encrypted and be protected with each of their session keys SAKs, thereby protecting the data exchanged between the devices. For example, when an attacker device 71 acquiring information capable of access to the VXLAN in which the device 10 and the device 20 participate accesses the VXLAN via an attacker VTEP 72, there is a risk of intercepting data exchanged between the device 10 and the device 20. However, since the data exchanged between the device 10 and the device 20 are protected under the MACsec protocol, the attacker device 71 cannot read the data exchanged between the devices 10 and 20. In other words, even if the attacker device 71 and the attacker VTEP 72 participate in the VXLAN tunnel by acquiring information to access the VXLAN, because the attacker device 71 and the attacker VTEP 72 that have not acquired the CAK from the authentication server 40 are not subject to an MACsec Key Association (MKA) process, they cannot decrypt the session keys of the devices 10 and 20 and cannot read the data exchanged between the other devices 10 and 20.

So far, the network system according to some embodiments of the present disclosure has been described with reference to FIGS. 2 to 4.

The network system according to the present embodiments may provide safer communication than the network system (see FIG. 1) in which the network between the client device and the server consists of the public Internet, and may be established at a lower cost than the network system in which the network between the client device and the server consists of the trusted Internet.

The network system according to the present embodiments may include the plurality of broker nodes 30-1 to 30-4 connected via the trusted Internet, where each of the relay nodes 30-1 to 30-4 and the client 10 or the server 20 can be connected to each other via the public Internet. The network system may provide virtual overlay networks separated for each service by forming the L2TP tunnel in a public Internet section between the relay nodes 30-1 to 30-4 and the client 10 or the server 20 and forming a plurality of VXLAN tunnels between the relay nodes 30-1 to 30-4 connected via the trusted Internet, and also, the network system may use the public Internet network together, thus eliminating the limitation on the distance to which the overlay network is connected. In addition, by providing the virtual overlay networks using the VXLAN tunnel, the network system can provide 16 million or more separate networks, which is a large number of networks, as a virtually unlimited number.

The relay nodes 30-1 to 30-4 of the network system according to the present embodiments may operate as the LNS of the L2TP tunnel and simultaneously as the VTEP of the VXLAN. The relay nodes 30-1 to 30-4 may connect the L2TP tunnel formed between the relay nodes and the client 10 or the server 20 in a public Internet section to the VXLAN tunnel formed between different relay nodes 30-1 to 30-4 in a trusted Internet section, thereby ultimately providing a layer 2-based virtual overlay network between the client 10 and the sever 20. In addition, the network system may provide high security by securely performing authentication and end-to-end encryption via the relay nodes instead of local gateways that may be vulnerable to security.

The network system according to the embodiments of the present disclosure may provide MACsec security authentication using an 802.1X authentication server, and even if the attacker device 71 acquires access information to the virtual overlay network (e.g., VXLAN) and participates in the network, the attacker device 71 that has not acquired the CAK from the authentication server cannot decrypt the session keys of other devices. Therefore, the authenticated devices can protect data exchanged over the virtual overlay network.

Since the layer 2-based virtual overlay network provided by the network system according to the present embodiments requires less computing power than the TCP/IP-based VPN network, small and lightweight terminals with limited resources may more smoothly use the service. The MACsec protocol requires no additional key exchange for each session and can use symmetric keys to result in high encryption efficiency, thereby reducing network bandwidth and decreasing CPU and memory resource usage for small and lightweight terminals.

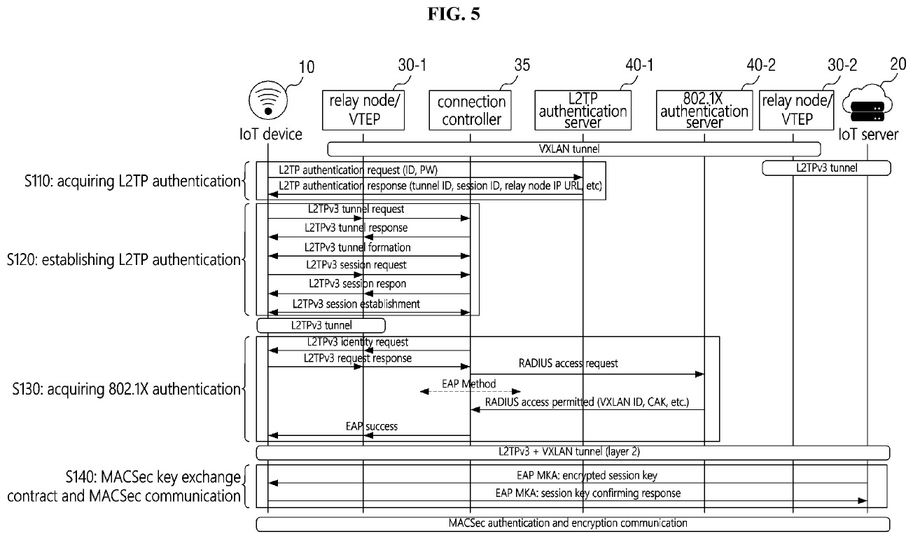

Hereinafter, a process of establishing a connection between devices in an exemplary network system according to another embodiment of the present disclosure will be described with reference to FIG. 5.

FIG. 5 illustrates messages transmitted and received between entities constituting the network system in a process of establishing a connection between the IoT device 10 and the IoT server 20 in a network system for providing the IoT service according to the present embodiment.

Referring to FIG. 5, it is assumed that the relay node 30-1, a connection controller 35, an L2TP authentication server 40-1, an 802.1X authentication server 40-2, and a relay node 30-2 are connected to each other via the trusted Internet, and the VXLAN tunnel is formed between the relay node 30-1 and the relay node 30-2. In addition, it is assumed that the L2TP tunnel is formed between the relay node 30-2 and the IoT server 20.

First, in a step 110, the IoT device 10 acquires L2TP authentication from the L2TP server 40-1. Specifically, the apparatus 10 may transmit an L2TP authentication request including its own identification information ID and password PW to the L2TP authentication server 40-1. When the device 10 is an authorized device, the L2TP authentication server 40-1 may transmit authentication information including L2TP session information to the device 10. Herein, the authentication information may include network address information (IP address and/or URL) of the relay node 30-1 adjacent to the device 10 and, a tunnel ID and a session ID used to form the L2TP tunnel.

In step 120, the IoT device 10 may form the L2TPv3 tunnel and an L2TPv3 session between the IoT device 10 and the relay node 30-1 by transmitting/receiving an L2TP tunnel request/response message and an L2TP session request/response message to/from the connection controller 35 or the relay node 30-1. Herein, the connection controller 35 is an entity configured to control the relay node 30-1, and may be configured with hardware separate from the relay node 30-1, but may be integrated into the relay node 30-1. In the step 120, the IoT device 10 may form the L2TPv3 tunnel and session between the IoT device 10 and the relay node 30-1 that is physically the closest among the plurality of relay nodes.

With the complement of the step 120, the IoT device 10 connected to the public Internet may be connected to the relay node 30-1 connected to the trusted Internet, via an L2TPv3 tunnel.

In a step 130, the IoT device 10 may acquire 802.1X authentication from the authentication server 40-2. Specifically, the connection controller 35 (or the relay node 30-1) may request, for example, identity information on EAPoL authentication from the device 10, and the device 10 may provide its own EAPoL authentication request information to the connection controller 35. The connection controller 35 may acquire authentication of the device 10 from the authentication server 40-2, for example, via a RADIUS protocol using the authentication request information of the device 10. When the device 10 is an authorized device, the authentication server 40-2 may provide the VXLAN ID and CAK of the virtual overlay network to which the device 10 is to participate, to the device 10, as an attribute value pair (AVP). Herein, the VXLAN ID may be identification information of the VXLAN associated with the IoT server 20 to which the IoT device 10 desires to communicate. The relay node 30-1 may connect the L2TPv3 tunnel connected with the device 10 to the VXLAN tunnel corresponding to the VXLAN ID.

With the completion of the step 130, the IoT device 10 may be connected to the same virtual overlay network VXLAN as the IoT server 20 via the relay node 30-1 configured to provide the layer 2-based L2TPv3 tunnel and the VXLAN tunnel, and acquire the CAK necessary to exchange data with another device on the virtual overlay network.

In a step 140, the device 10 may perform a MACsec key exchange contract MKA, and then perform communication protected by the MACsec protocol. Specifically, the device 10 may derive the key encryption key (KEK) from the CAK acquired in the step 130, that is, the shared key. For example, the device 10 may acquire the key encryption key KEK by inputting the shared key CAK acquired from the authentication server 40-1 into the predefined function. The device 10 may acquire the session key SAK of the encrypted server 20 from the server 20 using the key encryption key, and may decrypt the encrypted session key using the key encryption key. The device 10 may transmit a message to the server 20 indicating that the session key of the server 20 has been successfully received and decrypted, and then the server may decrypt and read data that is encrypted and transmitted using its own session key SAK.

With the completion of the step 140, MACsec authentication for the device to exchange MACsec-encrypted data with the server 20 may be completed to safely exchange data between the device 10 and the server 20.

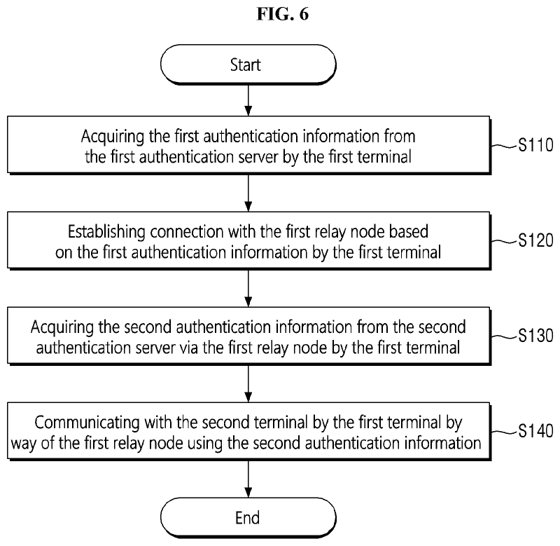

FIG. 6 is a flowchart illustrating an exemplary method in which a first terminal communicates with a second terminal in a network system according to some embodiments of the present disclosure. The following steps 110 to S140 to be described with reference to FIG. 6 may be understood as operations performed by the IoT device 10 while establishing the connection between the IoT device 10 and the IoT server 20 in the network system described with reference to FIG. 5, but the present disclosure is not limited thereto. In other words, in the following description, a first terminal may be, for example, the IoT device 10 of the embodiment described with reference to FIG. 5, and a second terminal may be, for example, the IoT server 20 of the embodiment.

The embodiment illustrated in FIG. 6 is only an embodiment for achieving the purpose of the embodiments of the present disclosure, and some steps may be added or deleted as needed. Each step of the communication method illustrated in FIG. 6 may be performed by the first terminal, for example, the IoT devices 10, 10-1, and 10-2. Each step of the communication method may be implemented with one or more instructions executed by a processor of a computing device. All steps included in the communication method may be performed by one physical computing device, but the first steps of the method may be performed by a first computing device, and the second steps of the method may be performed by a second computing device. Hereinafter, the description will be continued assuming that each step of the communication method is performed by the first terminal. However, for convenience of explanation, the descriptions of the subject for operating each of the steps included in the communication method may be omitted herein.

Although not otherwise mentioned, the technical idea of the embodiments described above with reference to FIGS. 2 to 5 may also be reflected in each of the operations of the communication method according to the present embodiment. On the contrary, the technical idea reflected in each of the operations of the communication method according to the present embodiment may also be reflected in the configuration and operation of the network system described with reference to FIGS. 2 to 5.

First, in the step 110, the first terminal may transmit the authentication request information to the authentication server, and when the authentication is successful, a first authentication information may be acquired from the authentication server. As described above, the first terminal may be the IoT devices 10, 10-1, and 10-2, and the authentication server may be the L2TP authentication server 40-1. The authentication request information may include identification information and password information of the first terminal. The first authentication information may include an identifier, a network address, an L2TP tunnel ID, and an L2TP session ID of a relay node closest to the first terminal among the plurality of relay nodes. Herein, the relay node closest to the first terminal may be a relay node physically closest to the first terminal, but may be a relay node logically closest to the first terminal, i.e., a relay node with the shortest network latency between the relay node and the first terminal.

In the step 120, the first terminal may establish the connection with the relay node using the first authentication information. Specifically, the L2TPv3 tunnel may be formed with the relay node and the L2TPv3 session may be generated by using the network address, the tunnel ID and the session ID of the relay node that are included in the first authentication information. The step 120 may include a step in which the first terminal and the relay node exchange the L2TP tunnel request/response message and/or the L2TP session request/response message with each other. With the completion of the step 120, the first terminal may be connected to the relay node via the L2TPv3 tunnel.

In the step 130, the first terminal may acquire a second authentication information from the authentication server via the relay node. Herein, the authentication server may be the 802.1X authentication server 40-2. Specifically, the relay node may request, for example, identity information for the EAPoL authentication from the first terminal, and the first terminal may provide its own EAPoL authentication request information to the relay node. The relay node may acquire authentication of the first terminal from the authentication server, for example, via the RADIUS protocol, using the authentication request information of the first terminal. When the first terminal is the authorized device, the authentication server may provide the second authentication information to the first terminal. The second authentication information may include the identification information of the virtual overlay network in which the first terminal is to participate and the key information (shared key) for encrypted communication. Herein, the identification information of the virtual overlay network may be identification information (e.g., VXLAN ID) of a virtual overlay network (e.g., VXLAN) in which the second terminal to which the first terminal desires to communicate is participating. Furthermore, the shared key may be the CAK configured to perform communication with the second terminal according to the MACsec protocol.

In the step 140, the first terminal may communicate with the second terminal using the second authentication information. In this case, the first terminal may communicate with the second terminal by way of the relay node.

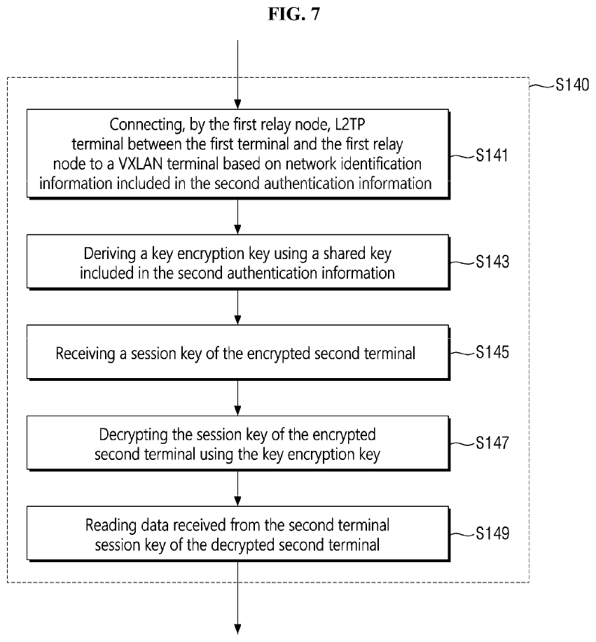

The step 140 will be described with reference to FIG. 7.

Specifically, the first terminal may participate in the virtual overlay network in which the second terminal participates by using the network identification information. In this case, the relay node may connect the L2TPv3 tunnel formed between the relay node and the first terminal to the VXLAN tunnel corresponding to the virtual overlay network identification information (e.g., the VXLAN ID), thus enabling the first terminal to participate in the virtual overlay network.

Meanwhile, the first terminal may protect the data exchanged with the second terminal by using the shared key (e.g., CAK) acquired in the step 130.

Specifically, the first terminal may acquire the key encryption key KEK by inputting the shared key included in the second authentication information into the predefined function (step 143).

The first terminal may receive the encrypted session key SAK of the second terminal from the second terminal (step 145) and decrypt the encrypted session key of the second terminal using the key encryption key KEK (step 147).

The first terminal may decrypt and read the encrypted data (payload) received from the second terminal using the decrypted session key SAK of the second terminal (step 149).

By performing steps S110 to S140 described so far, the layer 2-based virtual overlay network may be provided between the first terminal and the second terminal, and the first terminal and the second terminal may exchange data with each other in a secure manner.

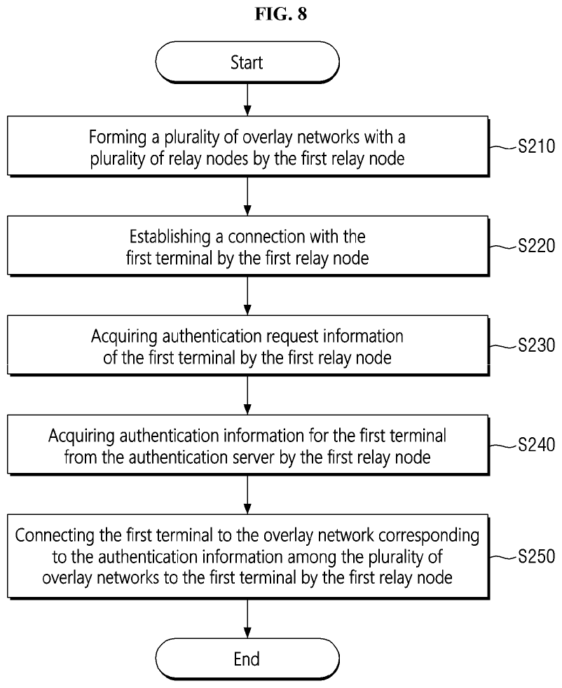

Hereinafter, exemplary operations performed by the relay node in the network system according to some embodiments of the present disclosure will be described with reference to FIG. 8. The following steps 210 toS250 to be described with reference to FIG. 8 may be understood as operations performed by the relay node 30-1 and/or the connection controller 35 during establishing the connection between the IoT device 10 and the IoT server 20 in the network system described with reference to FIG. 5, but the present disclosure is not limited thereto. In the following description, the first terminal may be, for example, the IoT device 10 of the embodiment described with reference to FIG. 5, the plurality of relay nodes may be, for example, the plurality of relay nodes 30-1 and 30-2 of the embodiment, and the authentication server may be the 802.1X authentication server 40-2 of the embodiment. In the following description, the first relay node may be a node that serves as both the L2TP network server (LNS) and the VXLAN tunnel endpoint (VTEP).

Referring to FIG. 8, first, in the step 210, the first relay node may form the plurality of relay nodes and a plurality of virtual overlay networks. Herein, forming the virtual overlay network may include forming the VXLAN tunnel between the plurality of relay nodes.

In the step 220, the first relay node may establish the connection with the first terminal. For example, the first relay node or the connection controller associated with the first relay node may receive the L2TP tunnel and an L2TP session forming request from the first terminal, and, in response thereto, may form an L2TPv2 tunnel and session with the first terminal.

In the step 230, the first relay node may acquire the authentication request information from the first terminal. More specifically, the first relay node or the connection controller associated with the first relay node may request, for example, the identity information for EAPoL authentication and acquire the EAPoL authentication request information from the first terminal.

In the step 240, the first relay node or the connection controller associated with the first relay node may acquire the authentication information for the first terminal from the authentication server. The first relay node may acquire the authentication information on the first terminal from the authentication server, for example, via the RADIUS protocol, using the authentication request information of the first terminal. Herein, the authentication server may be, for example, the 802.1X authentication server 40-2.

The authentication information may include the identification information of the virtual overlay network in which the first terminal is to participate and the key information (shared key) for the encrypted communication. Herein, the identification information of the virtual overlay network may be the identification information (e.g., VXLAN ID) of the virtual overlay network (e.g., VXLAN) in which the second terminal to which the first terminal desires to communicate is participating. Furthermore, the shared key may be the CAK configured to perform the communication with the second terminal according to the MACsec protocol.

In the step 250, in this case, the first relay node or the connection controller associated with the first relay node may connect the L2TPv3 tunnel formed between the relay node and the first terminal to the VXLAN tunnel corresponding to the virtual overlay network identification information (e.g., VXLAN ID), such that it enables the first terminal to participate in the virtual overlay network.

So far, referring to FIGS. 5 to 8, in the network system according to some embodiments of the present disclosure, the operations performed by the first terminal, the first replay node, the connection controller thereof, and authentication servers have been described to provide the layer 2-based virtual overlay network between the first terminal and the second terminal.

The operation method of the present embodiments may provide safer communication than the network system (see FIG. 1) in which the network between the client device and the server consists of the public Internet, and may be established at a lower cost than the network system in which the network between the client device and the server consists of the trusted Internet.

According to the operation method of the present embodiments, the virtual overlay network separated for each service may be provided by forming the L2TP tunnel in the public Internet section between the relay nodes 30-1 and 30-2 and the first terminal 10 or the second terminal 20, and forming the plurality of VXLAN tunnels between the relay nodes 30-1 and 30-2 connected via the trusted Internet.

According to the operation method of the present embodiments, the relay nodes 30-1 to 30-2 may operate as the LNS of the L2TP tunnel and simultaneously operate as the VTEP of the VXLAN. The relay nodes 30-1 to 30-2 may connect the L2TP tunnel formed between the relay nodes and the first terminal 10 or the second terminal 20 in the public Internet section to the VXLAN tunnel formed between the other relay nodes 30-1 and 30-2 in the trusted Internet section, thereby ultimately providing the layer 2-based virtual overlay network between the first terminal 10 and the second terminal 20.

According to the operating method of the present embodiments, the layer 2-based virtual overlay network may be provided that requires less computing power than the TCP/IP-based VPN network may be provided. Through the layer 2-based virtual overlay network, small and lightweight terminals with limited resources may more smoothly use the service.

According to the operational method of the present embodiments, there is provided the MACsec security authentication using the 802.1X authentication server, and even if the unauthorized device acquires the access information to the virtual overlay network (e.g., VXLAN) and participates in the network, the unauthorized device that has not acquired the CAK from the authentication server may not decrypt the session key of other devices. Therefore, the authenticated devices can protect the data exchanged over the virtual overlay network.

So far, the communication method and a system thereof via an overlay network according to some embodiments of the present disclosure have been described with reference to FIGS. 1 to 8.

The technical idea of the present disclosure described with reference to FIGS. 1 to 8 so far may be implemented with a computer-readable code on a computer-readable medium. The computer-readable recording medium may be, for example, a mobile recording medium (CD, DVD, a Blu-ray disk, a USB storage device, or a mobile hard disk), or a fixed recording medium (ROM, RAM, or a computer-equipped hard disk). The computer program recorded on the computer-readable recording medium may be transmitted to another computing device over a network such as the Internet and thus installed in the other computing device such that it is used in the other computing device.

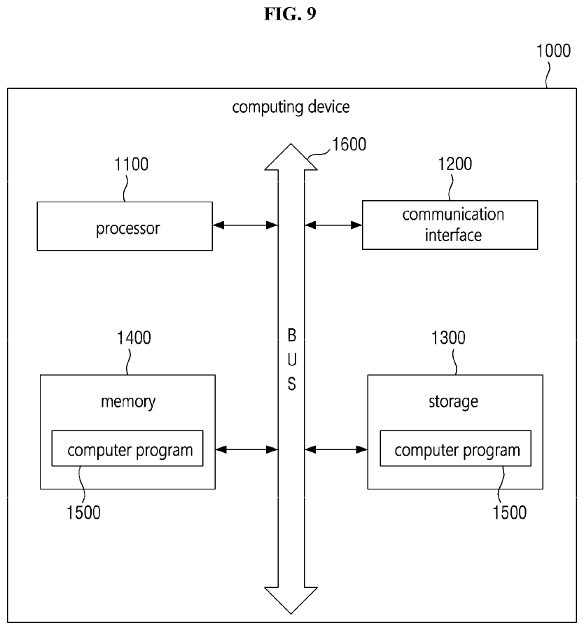

Hereinafter, a hardware configuration of an exemplary computing device according to some embodiments of the present disclosure will be described with reference to FIG. 9. The computing device to be described with reference to FIG. 9 may be a hardware configuration such as the IoT device 10, the IoT server 20, or the relay node 30-1 to 30-4 described with reference to FIGS. 2 to 5.

FIG. 9 is a view illustrating a hardware configuration of the terminal device described according to some embodiments of the present disclosure. The computing device 1000 may include one or more processors 1100, a system bus 1600, a communication interface 1200, a memory 1400 for loading a computer program 1500 performed by the processor 1100, and a storage 1300 for storing the computer program 1500.

The processor 1100 controls overall operations of each component of the computing device 1000. The processor 1100 may include at least one of a central processing unit (CPU), a micro-processor unit (MPU), a micro-controller unit (MCU), a graphical processing unit (GPU), or any type of processor known in the technical field of the present disclosure. In addition, the processor 1100 may perform arithmetic operations for at least one application or program for the purpose of executing the method/operation according to various embodiments of the present disclosure. The computing device 1000 may include two or more processors.

The memory 1400 stores different kinds of data, instructions, and/or information. The memory 1400 may load one or more computer programs 1500 from the storage 1300 to execute the methods/operations according to various embodiments of the present disclosure. An example of the memory 1400 may be RAM, but the present disclosure is not limited thereto. The system bus 1600 provides a communication function between components of the computing device 1000.

The system bus 1600 may be implemented with different kinds of buses such as an address bus, a data bus, and a control bus. The communication interface 1200 supports wired and wireless Internet communication of the computing device 1000. The communication interface 1200 may support a variety of communication methods other than Internet communication. To this end, the communication interface 1200 may include a communication module known in the technical field of the present disclosure. A storage 1300 may non-temporarily store one or more computer programs 1500. The storage 1300 may include non-volatile memories such as a flash memory, a hard disk, a removable disk, or any type of computer-readable recording medium known in the technical field to which the present disclosure belongs.

The computer program 1500 may include one or more instructions implemented with method/operation according to various embodiments of the present disclosure. When the computer program 1500 is loaded into the memory 1400, the processor 1100 may perform methods/operations according to various embodiments of the present disclosure by executing the one or more instructions.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A method for communicating between a first terminal and a second terminal, the method comprising:
acquiring a first authentication information from a first authentication server by the first terminal;
establishing a connection with a first relay node based on the first authentication information, by the first terminal;
acquiring a second authentication information from a second authentication server via the first relay node by the first terminal; and
communicating with the second terminal, by way of the first relay node and by using the second authentication information, by the first terminal.

2. The method of claim 1, wherein the first authentication information includes an address of a relay node closest to the first terminal among a plurality of relay nodes.

3. The method of claim 1, wherein the first authentication information includes a layer 2-based tunneling protocol (L2TP) tunnel identifier (ID) and an L2TP session ID for L2TP tunneling with the first relay node; and
the establishing of the connection with the first relay node comprises:
forming an L2TP tunnel between the first terminal and the first relay node by the first terminal; and
forming an L2TP session between the first terminal and the first node node via the L2TP tunnel by the first terminal.

4. The method of claim 1, wherein the acquiring of the second authentication information comprises:
acquiring authentication request information of the first terminal by using an extensible authentication protocol over local area network (EAPoL protocol) by the first relay node; and
acquiring the second authentication information for the first terminal from the second authentication server using a remote authentication dial-in user service (RADIUS) protocol by the first relay node.

5. The method of claim 1, wherein the second authentication information includes network identification information; and
the communicating with the second terminal by the first terminal comprises:
participating in an overlay network to which the second terminal belongs, by the first terminal, based on the network identification information.

6. The method of claim 5, wherein the participating in an overlay network to which the second terminal belongs, by the first terminal comprises:
connecting a layer 2-based tunneling protocol (L2TP) tunnel formed between the first terminal and the first relay node to a virtual extensible local area network (VXLAN) tunnel corresponding to the network identification information by the first relay node.

7. The method of claim 1, wherein the second authentication information includes a shared key; and
the communicating with the second terminal by the first terminal comprises:
communicating with the second terminal by using the shared key by the first terminal.

8. The method of claim 7, wherein the communicating with the second terminal using the shared key by the first terminal comprises:
deriving a key encryption key, based on the shared key by the first terminal;
receiving an encrypted session key of the second terminal by the first terminal;
decrypting the session key of the second terminal using the key encryption key by the first terminal; and
reading data received from the second terminal using the decrypted session key of the second terminal by the first terminal.

9. The method of claim 1, wherein the communicating with the second terminal by the first terminal comprises:
performing communication between the first terminal and the second terminal protected by a media access control security (MACsec) protocol.

10. A communication relaying method for relaying communication between terminals on a network, the method comprising:
forming, by a first relay node, a plurality of overlay networks with a plurality of relay nodes including the first relay node;
establishing a connection with a first terminal by the first relay node;
acquiring authentication request information of the first terminal from the first terminal by the first relay node;
acquiring authentication information for the first terminal from an authentication server, based on the authentication request information; and
connecting the first terminal to an overlay network corresponding to the authentication information among the plurality of overlay networks by the first relay node.

11. The communication relaying method of claim 10, wherein the forming of the plurality of overlay networks comprises:
forming a plurality of virtual extensible local area network (VXLAN) tunnels between the plurality of relay nodes by the first relay node.

12. The communication relaying method of claim 10, wherein the establishing of the connection with the first terminal comprises:
forming a layer 2-based tunneling protocol (L2TP) tunnel between the first relay node and the first terminal by the first relay node.

13. The communication relaying method of claim 10, wherein the acquiring of authentication request information of the first terminal from the first terminal comprises:
acquiring the authentication request information using an extensible authentication protocol over local area network (EAPoL protocol) by the first relay node.

14. The communication relaying method of claim 10, wherein the acquiring of the authentication information for the first terminal from an authentication server comprises:
acquiring the authentication information from the authentication server using a remote authentication dial-in user service (RADIUS) protocol by the first relay node.

15. The communication relaying method of claim 10, wherein the connecting of the first terminal with the overlay network comprises:
connecting a layer 2-based tunneling protocol (L2TP) tunnel formed between the first relay and the first terminal to virtual extensible local area network (VXLAN) tunnel corresponding to the authentication information.

16. The communication relaying method of claim 10, wherein the first relay node is both a layer 2-based tunneling protocol (L2TP) network server and a virtual extensible local area network (VXLAN) tunnel endpoint.

17. A network system comprising:
a plurality of terminals comprising a first terminal and a second terminal;
a plurality of relay nodes comprising a first relay node, the plurality of relay nodes forming a plurality of overlay networks; and
an authentication server,
wherein the first terminal is configured to:
establish a connection with the first relay node closest to the first terminal among the plurality of relay nodes based on a first authentication information acquired from the authentication server;
acquire a second authentication information via the first relay node; and
perform communication between the first terminal and the second terminal, protected by a media access control security (MACsec) protocol by way of the first relay node using the second authentication information,
wherein the first relay node is configured to:
acquire the second authentication information for the first terminal to provide the second authentication information to the first terminal, based on authentication request information acquired from the first terminal; and
connect the first terminal to an overlay network corresponding to the second authentication information among the plurality of overlay networks.

18. The network system of claim 17, wherein the authentication server comprises:
a layer 2-based tunneling protocol (L2TP) authentication server configured to provide the first authentication information; and
an 802.1X authentication server configured to provide the second authentication information.

19. The network system of claim 17, wherein the first terminal and the first relay node are connected via a layer 2-based tunneling protocol (L2TP) tunnel, and the plurality of relay nodes are connected via a plurality of virtual extensible local area network (VXLAN) tunnels to form the plurality of overlay networks, and
the first relay node connects the L2TP tunnel to the VXLAN tunnel corresponding to the second authentication information among the plurality of VXLAN tunnels.

20. The network system of claim 17, wherein the first relay node is both a layer 2-based tunneling protocol (L2TP) network server and a virtual extensible local area network (VXLAN) tunnel endpoint.
